(19) United States
(12) Patent Application Publication
(10) Pub. No.: US 2022/0379944 A1
(43) Pub. Date: Dec. 1, 2022

(54) Plasti-guard shopping cart handle barrier

(71) Applicant: Oscar Bernal, Riverside, CA (US)

(72) Inventor: Oscar Bernal, Riverside, CA (US)

(21) Appl. No.: 17/335,741

(22) Filed: Jun. 1, 2021

(51) Int. Cl. B62B 5/06

(52) U.S. Cl. CPC B62B 5/069

(57) ABSTRACT

A handle barrier, including a main body impervious to liquid, the main body including an outer surface disposed on a first side of the main body, an inner surface disposed on a second side of the main body to connect the main body to a shopping cart handle, a first bent edge longitudinally disposed on at least a portion of a third side of the main body, and a second bent edge longitudinally disposed on at least a portion of a fourth side of the main body opposite with respect to the third side of the main body.

### BACKGROUND

### 1. Field

The present general inventive concept relates generally to a covering device, and particularly, to a handle barrier.

### 2. Description of the Related Art

Recent worldwide events are dominated by the coronavirus disease 2019 (COVID-19) pandemic. Moreover, COVID-19 has necessitated many new health guidelines. One of the important guidelines for to prevent the spread of disease includes cleaning of hands and/or cleaning of commonly used surfaces which minimizes contact with infectious fluids.

However, publicly utilized shopping carts and/or shopping cart handles require constant sanitization which can be tedious and non-effective in preventing transmissible infections. Additionally, the shopping cart handles that are not adequately sanitized, expose users to an increased risk of contamination.

Some covers of the shopping cart handle exist, but these covers are constructed of fabric and need to be cleaned at home. Unfortunately, cleaning these covers at home can bring the disease home. Also, fabric easily absorbs fluids, including saliva and/or other water droplets that are vectors for disease transmission.

Therefore, there is a need for a handle barrier that does not absorb fluids and can be easily disposed after use.

### SUMMARY

The present general inventive concept provides a handle barrier.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a handle barrier, including a main body impervious to liquid, the main body including an outer surface disposed on a first side of the main body, an inner surface disposed on a second side of the main body to connect the main body to a shopping cart handle, a first bent edge longitudinally disposed on at least a portion of a third side of the main body, and a second bent edge longitudinally disposed on at least a portion of a fourth side of the main body opposite with respect to the third side of the main body.

The first bent edge may be angularly disposed away from the third side toward the second bent edge, and the second bent edge is angularly disposed away from the fourth side toward the first bent edge.

The first bent edge and the second bent edge may facilitate snapping the main body on the shopping cart handle.

The inner surface may have an adhesive disposed thereon.

The main body may further include a first fastener disposed on at least a portion of a first edge at a first end of the main body to connect the first end of the main body to a first end of the shopping cart handle, and a second fastener disposed on at least a portion of a second edge at a second end of the main body to connect the second end of the main body to a second end of the shopping cart handle.

The main body may further include a perforated portion disposed on at least a portion of the third side of the main body and at least a portion of the fourth side of the main body to facilitate detaching the main body from another main body.

The main body may further include a plurality of protrusions disposed on at least a portion of the outer surface to facilitate gripping thereof.

The main body may be constructed as a thin film to at least partially deform in response to being disposed on the shopping cart handle.

The main body may be constructed as a rigid structure.

The handle barrier may further include a superhydrophobic coating disposed on at least a portion of the outer surface to prevent the liquid from contacting the outer surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a handle barrier, according to an exemplary embodiment of the present general inventive concept;

FIG. 2A illustrates a side perspective view of the handle barrier, according to an exemplary embodiment of the present general inventive concept;

FIG. 2B illustrates an elevational top view of the handle barrier, according to an exemplary embodiment of the present general inventive concept; and

FIG. 3 illustrates an isometric top view of the handle barrier as disposed in a barrier container, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Handle Barrier 100

Main Body 110

Outer Surface 111

Inner Surface 112

First Fastener 113

Second Fastener 114

First Bent Edge 115

Second Bent Edge 116

Protrusions 117

Perforated Portion 118

Tab 119

Superhydrophobic Coating 120

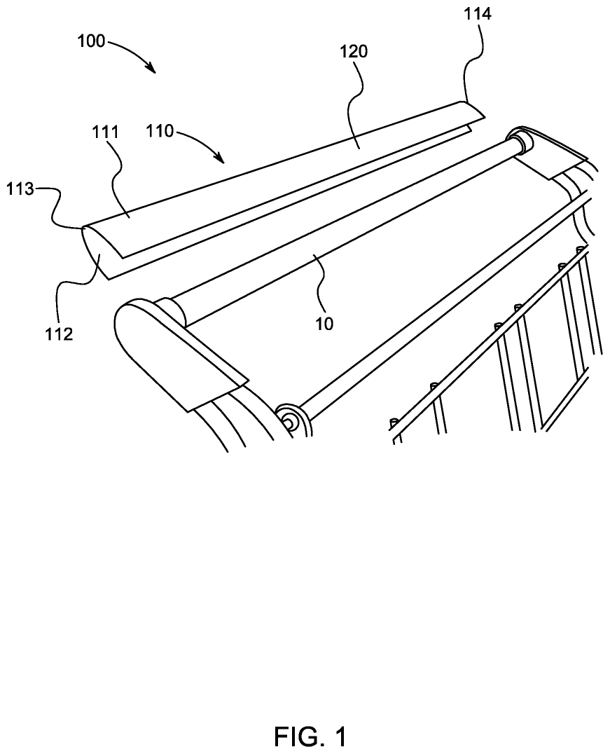

FIG. 1 illustrates a front perspective view of a handle barrier 100, according to an exemplary embodiment of the present general inventive concept.

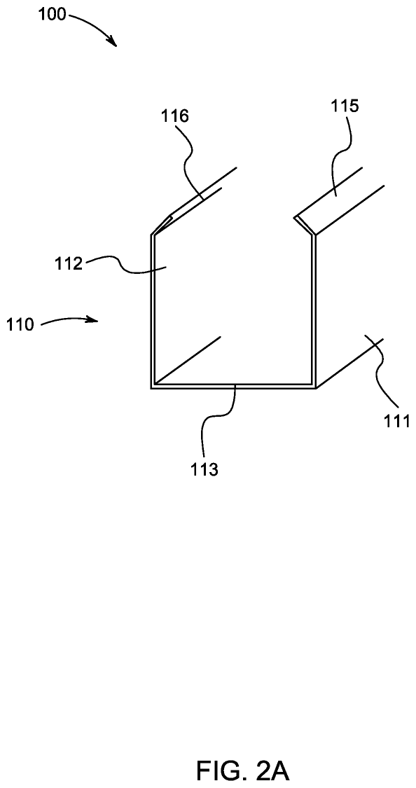

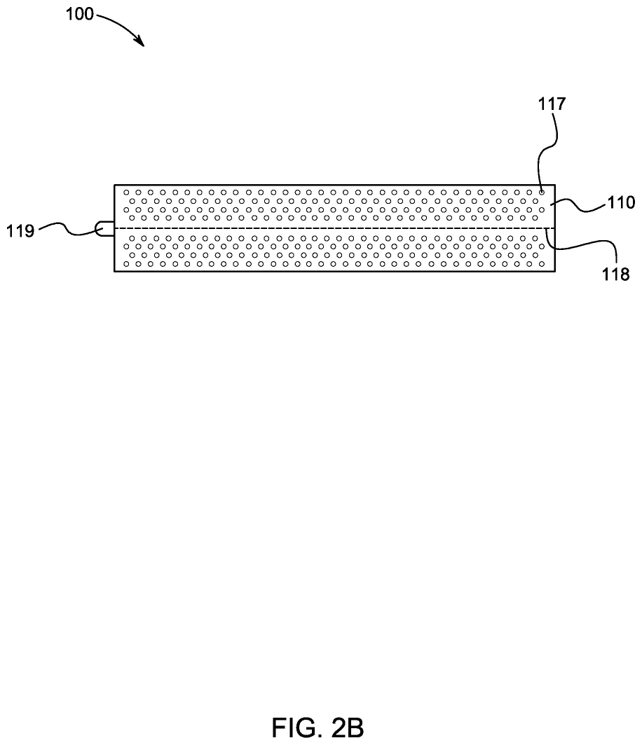

FIG. 2A illustrates a side perspective view of the handle barrier 100, according to an exemplary embodiment of the present general inventive concept.

FIG. 2B illustrates an elevational top view of the handle barrier 100, according to an exemplary embodiment of the present general inventive concept.

The handle barrier 100 may be constructed from at least one of plastic, cellulose, metal, wood, and rubber, etc., but is not limited thereto.

The handle barrier 100 may include a main body 110 and a superhydrophobic coating 120, but is not limited thereto.

The main body 110 may have a predetermined size (i.e. length, width, depth) corresponding to a size (i.e. length, width, circumference) of a shopping cart handle 10. In other words, the main body 110 may at least partially cover the shopping cart handle 10 while disposed on the shopping cart handle 10.

The main body 110 may be constructed as a thin film, such as a laminated substrate. Moreover, the main body 110 may be highly flexible, such that the main body 110 may at least partially deform (i.e. bend, stretch, expand) in response to being disposed on the shopping cart handle 10.

Alternatively, the main body 110 may be constructed as a rigid structure, such that the main body 110 may remain the same shape. However, the main body 110 may be disposed on the shopping cart handle 110 in a snap configuration. In other words, the main body 110 may have a concave and/or a crescent shape to at least partially cover the shopping cart handle 10 by snapping on to the shopping cart handle 10. As such, the main body 110 may prevent a portion of a body of a user, such as hands, from contacting the shopping cart handle 10. Therefore, the main body 110 may prevent contamination and/or spread of at least one pathogen (e.g., bacteria, virus, parasite, fungus). Additionally, the main body 110 may be non-porous to prevent a liquid (e.g., water, water droplets, vapor) from moving therethrough, such that the main body 110 may be impervious to the liquid.

Referring to FIGS. 1 through 2B, the main body 110 may include an outer surface 111, an inner surface 112, a first fastener 113, a second fastener 114, a first bent edge 115, a second bent edge 116, a plurality of protrusions 117, a perforated portion 118, and a tab 119, but is not limited thereto.

The outer surface 111 may be disposed on at least a portion of a first side of the main body 110. The inner surface 112 may be disposed on at least a portion of a second side of the main body 110 opposite with respect to the first side of the main body 110. Moreover, the inner surface 112 may be oriented, such that the inner surface 112 may contact the shopping cart handle 10.

Furthermore, the inner surface 112 may include an adhesive (e.g., glue, tape), but is not limited thereto. As such, the inner surface 112 may connect to the shopping cart handle 10 and/or resist removal from the shopping cart handle 10.

The first fastener 113 may include a magnet, but is not limited thereto.

The first fastener 113 may be disposed on at least a portion of a first edge at a first end of the main body 110. Moreover, the first fastener 113 may be located at the first edge to minimize increased construction size on a center portion of the main body 110. The first fastener 113 may connect the first end of the main body 110 to at least one ferromagnetic surface, such as a first end of the shopping cart handle 10.

The second fastener 114 may include a magnet, but is not limited thereto.

The second fastener 114 may be disposed on at least a portion of a second edge at a second end of the main body 110 opposite with respect to the first end of the main body 110. Moreover, the second fastener 114 may be located at the second edge to minimize increased construction size on the center portion of the main body 110. The second fastener 114 may connect the second end of the main body 110 to the at least one ferromagnetic surface, such as a second end of the shopping cart handle 10.

Referring again to FIG. 2A, the first bent edge 115 may be longitudinally disposed on at least a portion of a third side of the main body 110. In other words, the first bent edge 115 may extend at least a portion of a length of the main body 110. Additionally, the first bent edge 115 may be angularly disposed (i.e. bent) away from the third side of the main body 110 with respect to a first direction. For example, the main body 110 may have a cube shape, such that a side of the cube may not be contiguous and form a gap between two sides. As such, the first bent edge 115 may be angularly disposed toward a center of the gap.

Similarly, the second bent edge 116 may be longitudinally disposed on at least a portion of a fourth side of the main body 110. In other words, the second bent edge 116 may extend at least a portion of the length of the main body 110. Additionally, the second bent edge 116 may be angularly disposed (i.e. bent) away from the fourth side of the main body 110 with respect to a second direction different from the first direction. For example, the main body 110 may have a cube shape, such that a side of the cube may not be contiguous and form a gap between two sides (i.e. the third side and the fourth side). As such, the second bent edge 116 may be angularly disposed toward the center of the gap, and also toward the third side. Also, the first bent edge 115 may be angularly disposed toward the fourth side.

As such, the first bent edge 115 and/or the second bent edge 116 may facilitate snapping the main body 110 on the shopping cart handle 10. Furthermore, the first bent edge 115 and/or the second bent edge 116 may resist removal from the shopping cart handle 10 while connected to the shopping cart handle 10.

Each of the plurality of protrusions 117 may include a raised bump that is circular, rectangular, and/or any other shape known to one of ordinary skill in the art.

The plurality of protrusions 117 may be disposed on at least a portion of the outer surface 111. Therefore, the plurality of protrusions 117 may facilitate gripping thereof.

The perforated portion 118 may be disposed on at least a portion of the third side and/or the fourth side of the main body 110. As such, the perforated portion 118 may be disposed on at least a portion of an edge of the first bent edge 115 and/or at least a portion of an edge of the second bent edge 116. Accordingly, the perforated portion 118 may separate the main body 110 from another main body 110. The perforated portion 118 may facilitate detaching the main body 110 from the another main body 110.

The tab 119 may be disposed on at least a portion of the first end and/or the second end of the main body 110. The tab 119 may facilitate gripping the first end and/or the second end of the main body 110. More specifically, the tab 119 may facilitate detaching the main body 110 from the another main body 110 along the perforated portion 118.

The superhydrophobic coating 120 may include manganese oxide polystyrene, zinc oxide polystyrene, precipitated calcium carbonate, silica nano-coating, and fluoropolymer coating, but is not limited thereto.

The superhydrophobic coating 120 may be disposed on at least a portion of the outer surface 111. The superhydrophobic coating 120 may prevent the liquid from contacting the main body 110. In other words, the superhydrophobic coating 120 may create a layer covering the outer surface 111 of the main body 110.

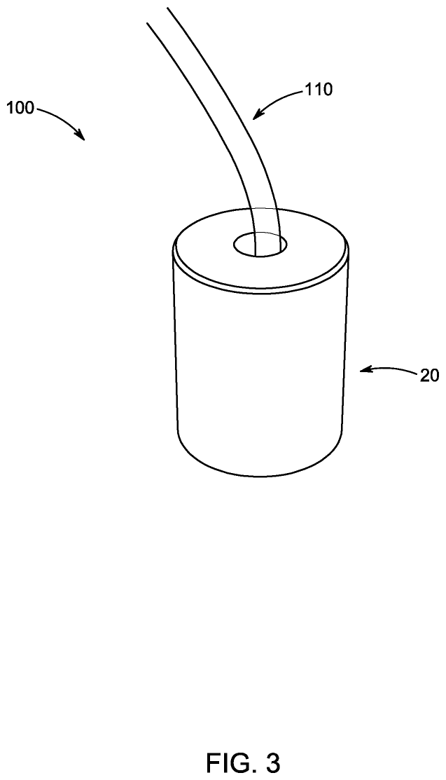

FIG. 3 illustrates an isometric top view of the handle barrier 100 as disposed in a barrier container 20, according to an exemplary embodiment of the present general inventive concept.

The main body 110 may be stored in a barrier container 20. The main body 110 as a thin film may be rolled within the barrier container 20, such that the main body 110 may be extracted and/or detached from the barrier container 20. As such, the main body 110 may be used on the shopping cart handle 10 and disposed after use.

Therefore, the handle barrier 100 may prevent the liquid from being absorbed. Also, the handle barrier 100 may be disposed after use.

The present general inventive concept may include a handle barrier 100, including a main body 110 impervious to liquid, the main body 110 including an outer surface 111 disposed on a first side of the main body 110, an inner surface 112 disposed on a second side of the main body 110 to connect the main body 110 to a shopping cart handle 10, a first bent edge 115 longitudinally disposed on at least a portion of a third side of the main body 110, and a second bent edge 116 longitudinally disposed on at least a portion of a fourth side of the main body 110 opposite with respect to the third side of the main body 110.

The first bent edge 115 may be angularly disposed away from the third side toward the second bent edge 116, and the second bent edge 116 is angularly disposed away from the fourth side toward the first bent edge 115.

The first bent edge 115 and the second bent edge 116 may facilitate snapping the main body 110 on the shopping cart handle 10.

The inner surface 112 may have an adhesive disposed thereon.

The main body 110 may further include a first fastener 113 disposed on at least a portion of a first edge at a first end of the main body 110 to connect the first end of the main body 110 to a first end of the shopping cart handle 10, and a second fastener 114 disposed on at least a portion of a second edge at a second end of the main body 110 to connect the second end of the main body 110 to a second end of the shopping cart handle 10.

The main body 110 may further include a perforated portion 118 disposed on at least a portion of the third side of the main body 110 and at least a portion of the fourth side of the main body 110 to facilitate detaching the main body 110 from another main body 110.

The main body 110 may further include a plurality of protrusions 117 disposed on at least a portion of the outer surface 111 to facilitate gripping thereof.

The main body 110 may be constructed as a thin film to at least partially deform in response to being disposed on the shopping cart handle 10.

The main body 110 may be constructed as a rigid structure.

The handle barrier 100 may further include a superhydrophobic coating 120 disposed on at least a portion of the outer surface 111 to prevent the liquid from contacting the outer surface 111.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A handle barrier, comprising:
a main body impervious to liquid, the main body comprising:
an outer surface disposed on a first side of the main body,
an inner surface disposed on a second side of the main body to connect the main body to a shopping cart handle,
a first bent edge longitudinally disposed on at least a portion of a third side of the main body, and
a second bent edge longitudinally disposed on at least a portion of a fourth side of the main body opposite with respect to the third side of the main body.

2. The handle barrier of claim 1, wherein the first bent edge is angularly disposed away from the third side toward the second bent edge, and the second bent edge is angularly disposed away from the fourth side toward the first bent edge.

3. The handle barrier of claim 1, wherein the first bent edge and the second bent edge facilitate snapping the main body on the shopping cart handle.

4. The handle barrier of claim 1, wherein the inner surface has an adhesive disposed thereon.

5. The handle barrier of claim 1, wherein the main body further comprises:
a first fastener disposed on at least a portion of a first edge at a first end of the main body to connect the first end of the main body to a first end of the shopping cart handle; and
a second fastener disposed on at least a portion of a second edge at a second end of the main body to connect the second end of the main body to a second end of the shopping cart handle.

6. The handle barrier of claim 5, wherein the main body further comprises:
a perforated portion disposed on at least a portion of the third side of the main body and at least a portion of the fourth side of the main body to facilitate detaching the main body from another main body.

7. The handle barrier of claim 1, wherein the main body further comprises:
a plurality of protrusions disposed on at least a portion of the outer surface to facilitate gripping thereof.

8. The handle barrier of claim 1, wherein the main body is constructed as a thin film to at least partially deform in response to being disposed on the shopping cart handle.

9. The handle barrier of claim 1, wherein the main body is constructed as a rigid structure.

10. The handle barrier of claim 1, further comprising:
a superhydrophobic coating disposed on at least a portion of the outer surface to prevent the liquid from contacting the outer surface.
